(19) United States
(12) Patent Application Publication
(10) Pub. No.: US 2006/0048612 A1
(43) Pub. Date: Mar. 9, 2006

(54) Tool for removal of receiver hitch inserts

(76) Inventor: Tiemen J. van der Horn, Richmond (CA)

Correspondence Address: Tiemen J. van der Horn, P.O. Box 764, Richmond, ON, KOA 2Z0, CA

(21) Appl. No.: 10/944,112

(22) Filed: Sep. 20, 2004

(30) Foreign Application Priority Data
Sep. 7, 2004 (CA) 2,474,102

(51) Int. Cl. B25B 13/48; B25B 13/56

(52) U.S. Cl. 81/176.1

(57) ABSTRACT

A tool for removal of devices inserted to a receiver hitch is described. The tool is known to have a metal disc attached to a handle, and a fulcrum pin on the metal disc of the tool which inserts to one of a series of holes drilled into the receiver hitch insert for that purpose. The tool, when inserted to a drilled hole in the receiver hitch insert and manually rotated will act as a lever which enables one to remove the insert more easily.

### FIELD OF THE INVENTION

This invention relates to a manually operable tool for removing inserts and accessories from a Receiver (trailer) Hitch.

### BACKGROUND OF THE INVENTION

Several devices are available which, when in use, must be inserted to a receiver hitch on a vehicle. Any insert for a trailer Receiver Hitch must be designed to fit snugly to eliminate excessive movement. Because of this, it is often difficult to impossible to remove an insert manually, as it can bind in the receiver hitch.

No prior art has been found to offer a solution to this problem.

It would be beneficial to have a small, cost effective tool to enable one to manually remove an insert from a receiver hitch using considerably less effort.

### SUMMARY OF THE INVENTION

The invention describes a manually operated hand tool, comprising:
a metal disc, the flat side of which, when in use, lies flat against the portion of the insert which enters a receiver hitch, and the side edge of which, when is use contacts the proximal edge of the receiver hitch.
a metal fulcrum pin which is mechanically coupled or welded to the flat side of the metal disc, in from the edge of the disc. Said fulcrum pin is inserted to one of a series of holes drilled into a face of the insert.
a handle which is mechanically coupled or welded to the flat side of the metal disc on the opposite side from the fulcrum pin.

### BRIEF DESCRIPTION OF THE DRAWINGS

The invention will now be described with respect to the drawings in which:

FIG. 1 is showing a plan view and a side view of the tool according to the first embodiment of the invention.

FIG. 2 is a side view of the tool according to the first embodiment of the invention engaged with the insert.

FIG. 3 is a plan view of the tool according to the first embodiment of the invention engaged with the insert.

FIG. 4 is a side view of the tool according to the first embodiment of the invention engaged with the insert.

FIG. 5 is a plan view and a side view of a variation of the tool according to an embodiment of the invention with four threaded holes drilled into one side of the metal disc and no fixed fulcrum pin.

FIG. 6 is a plan view of the variable positioning fulcrum pin for insertion to an embodiment of the invention described in FIG. 5.

### DETAILED DESCRIPTION OF THE INVENTION

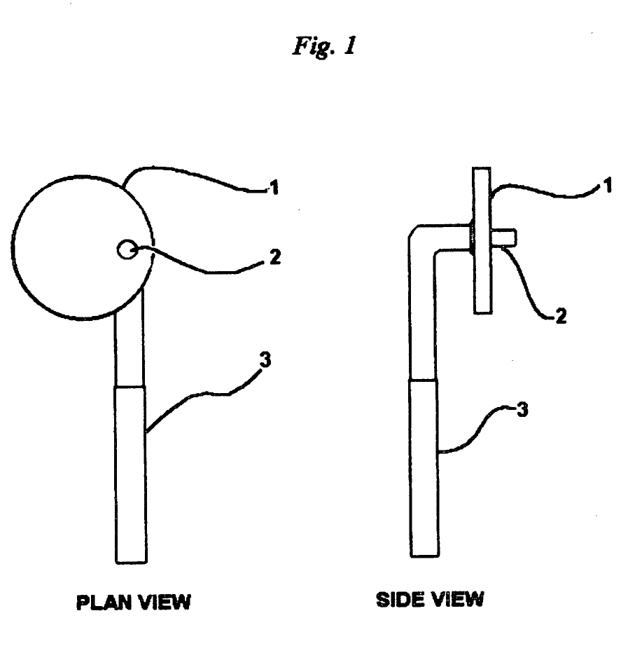

Referring to FIG. 1, a tool according to a first embodiment of the invention is shown. The tool comprises a metal disc 1, to which a fulcrum pin 2 has been welded on one flat side, and a handle 3 has been welded to the opposite flat side of the disc 1.

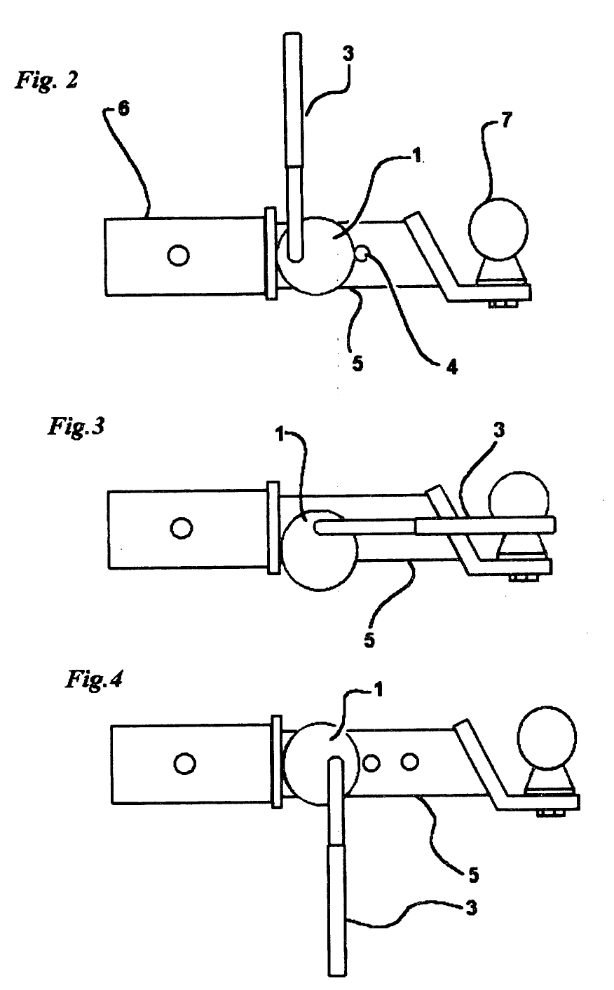

Referring to FIG. 2 a tool according to a first embodiment of the invention is shown positioned with fulcrum pin 2 inserted to one of a series of holes 4 drilled into the side of the insert 5 and the handle 3 positioned vertically upward.

As shown in FIG. 3, the handle 3 is turned clockwise from the position shown in FIG. 2, the fulcrum pin is placed in another of the series of holes 4, as the tool operates as a lever, moving the insert 5 in the receiver hitch 6.

The handle 3 is rotated further clockwise, refer to FIG. 4, and the fulcrum pin 2 is moved to others of the series of holes 4 until the insert 5 is removed from the receiver 6.

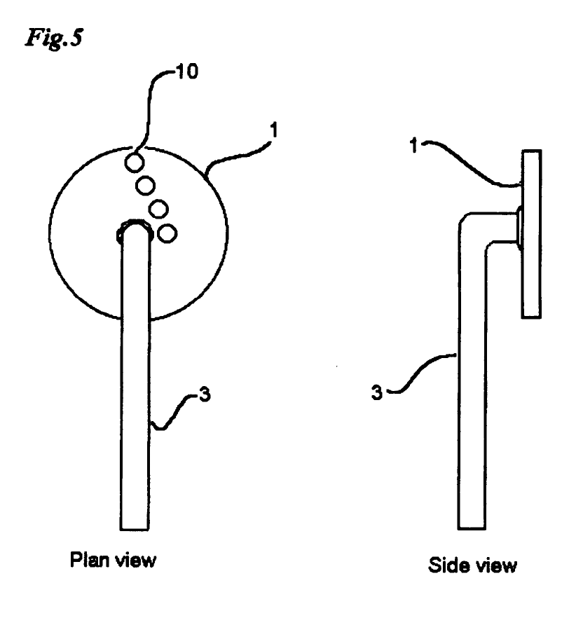

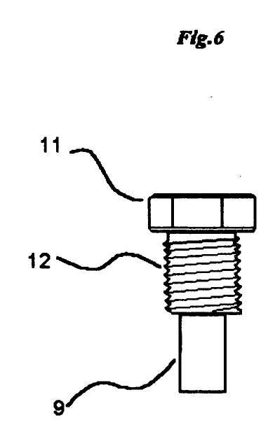

Referring to FIG. 5, a variation of the tool according to the first embodiment of the invention is shown with a metal disc 1, a handle 3 welded to a flat side of the disc 1 and with a series of holes 10 drilled through the flat side of the disc 1. Said holes are threaded to accept the threading 12 of the variable positioning fulcrum pin, see FIG. 6.

The pin illustrated in FIG. 6 has a head 11 on one end designed to be turned by a wrench or socket, a threaded portion 12 in the centre matched to the threads in the holes of the metal disc 1 shown on FIG. 5, and a fulcrum pin formed at the second end to fit into holes 4 in the insert 5.

Another variation of a tool according to the first embodiment of the invention would include a receptacle formed in the disc to allow a wrench or breaker bar to be used as a handle.

Still another variation features a handle according to the first embodiment of the invention, a fulcrum pin, and a second pin parallel to and shorter than the fulcrum pin. The second pin is to be placed against the proximal edge of the receiver hitch and used as a lever.

What is claimed is:

1. A manually operable tool for removing devices which are made for insertion to a receiver hitch, comprising a metal disc, a handle mechanically coupled or welded to the disc, and a fulcrum pin mechanically coupled or welded to the disc. Fulcrum pin is to be inserted to a hole in the insert, and the metal disc is to be placed flat against the insert with the edge against the proximal edge of the receiver hitch, and the handle is to be rotated to act as a lever.

2. A tool as defined in claim 1, in which the metal disc has a series of drilled, threaded holes for varying the position of the fulcrum pin, and the fulcrum pin is a separate, manually attachable pin with a head designed to be turned by a wrench or socket, a centre threaded portion, and a formed fulcrum pin.

3. A tool as defined in claim 1, in which a receptacle is formed in the metal disc to allow a wrench or a breaker bar to be used as a handle.

4. A tool as defined in claim 1, in which two pins, a fulcrum pin and a second shorter pin, are formed at one end of the handle, to be used as a lever.
